(19) United States
(12) Patent Application Publication
(10) Pub. No.: US 2018/0027240 A1
(43) Pub. Date: Jan. 25, 2018

(54) VIDEO ENCODING APPARATUS FOR ENCODING VIDEO FRAME SEGMENT THAT IS PARTITIONED INTO MULTIPLE COLUMN TILES AND ASSOCIATED VIDEO ENCODING METHOD

(71) Applicant: MEDIATEK INC., Hsin-Chu (TW)

(72) Inventors: Yen-Chao Huang, Taichung City (TW); Li-Heng Chen, Tainan City (TW); Tung-Hsing Wu, Chiayi City (TW); Chung-Hua Tsai, Kaohsiung City (TW); Lien-Fei Chen, Taoyuan City (TW); Han-Liang Chou, Hsinchu County (TW)

(21) Appl. No.: 15/653,550

(22) Filed: Jul. 19, 2017

Related U.S. Application Data
(60) Provisional application No. 62/364,906, filed on Jul. 21, 2016.

(51) Int. Cl. H04N 19/159; H04N 19/50; H04N 19/176; H04N 19/61

(52) U.S. Cl. CPC H04N 19/159; H04N 19/61; H04N 19/50; H04N 19/176

(57) ABSTRACT

A video encoding apparatus has a bitstream buffer and a first video encoder. The first video encoder sequentially encodes coding blocks of a first video frame segment in a first encoding order, and outputs encoded data of the coding blocks of the first video frame segment to the bitstream buffer. The first video frame segment is partitioned into a plurality of column tiles, each having at least one tile. The first encoding order is identical to an encoding order of encoding a video frame segment with only a single column tile.

### CROSS REFERENCE TO RELATED APPLICATIONS

This application claims the benefit of U.S. provisional application No. 62/364,906, filed on Jul. 21, 2016 and incorporated herein by reference.

### BACKGROUND

The present invention relates to a video compression technique, and more particularly, to a video encoding apparatus for encoding a video frame segment (e.g., a complete video frame or a partial video frame) that is partitioned into multiple column tiles and an associated video encoding method.

The conventional video coding standards generally adopt a block based coding technique to exploit spatial and temporal redundancy. For example, the basic approach is to divide the whole source frame into a plurality of blocks, perform intra prediction/inter prediction on each block, transform residues of each block, and perform quantization, scan and entropy encoding. Besides, a reconstructed frame is generated in a coding loop to provide reference pixel data used for coding following blocks in an inter prediction mode. In addition, in-loop filter(s) may be used for enhancing the image quality of the reconstructed frame.

For certain video coding standards, one video frame may be partitioned into a plurality of tiles, where each of the tiles includes a plurality of coding blocks (which are basic processing units of video encoding), and each of the coding blocks includes a plurality of pixels. In general, tiles in one video frame are encoded in a raster scan order, and coding blocks in one tile are encoded in a raster scan order. When a coding block is encoded under an inter prediction mode, reference pixels in a search window are required to be loaded from a reference frame buffer to a local buffer of a video encoder for motion estimation. However, when tiles in one video frame are encoded in a raster scan order and coding blocks in one tile are encoded in a raster scan order, some of the reference pixels loaded for motion estimation of a current coding block on a left side of a vertical tile boundary may not be reused for motion estimation of a next coding block on a right side of the vertical tile boundary due to spatial discontinuity under the conventional encoding order. The buffer bandwidth overhead exists due to frequent access of the reference frame buffer.

If a deblocking filter is used as an in-loop filter, reconstructed pixels of pixel columns on a left side of a vertical tile boundary are needed for removing blocking artifacts around the tile boundary when reconstructed pixels of pixel columns on a right side of the vertical tile boundary are obtained. However, when tiles in one video frame are encoded in a raster scan order and coding blocks in one tile are encoded in a raster scan order, an additional column buffer is needed to store reconstructed pixels of pixel columns on the left side of the vertical tile boundary, thus resulting in a higher buffer cost and a larger chip area.

Thus, there is a need for a low-cost and high-performance video encoder design for multi-tile video frame encoding.

### SUMMARY

One of the objectives of the claimed invention is to provide a video encoding apparatus for encoding a video frame segment (e.g., a complete video frame or a partial video frame) that is partitioned into multiple column tiles and an associated video encoding method.

According to a first aspect of the present invention, an exemplary video encoding apparatus is disclosed. The exemplary video encoding apparatus includes a bitstream buffer and a first video encoder. The first video encoder is arranged to sequentially encode coding blocks of a first video frame segment in a first encoding order, and output encoded data of the coding blocks of the first video frame segment to the bitstream buffer, wherein the first video frame segment is partitioned into a plurality of column tiles each having at least one tile, and the first encoding order is identical to an encoding order of encoding a video frame segment with only a single column tile.

According to a second aspect of the present invention, an exemplary video encoding apparatus is disclosed. The first video encoder is arranged to sequentially encode coding blocks of a first video frame segment, and output encoded data of the coding blocks of the first video frame segment to the bitstream buffer, wherein the first video frame segment is partitioned into a plurality of column tiles each having at least one tile, and adjacent coding blocks located at a same coding block row and located on opposite sides of a column tile boundary are encoded by the first video encoder sequentially.

According to a third aspect of the present invention, an exemplary video encoding apparatus is disclosed. The exemplary video encoding apparatus includes a bitstream buffer and a first video encoder. The first video encoder is arranged to sequentially encode coding blocks of a first video frame segment, and output encoded data of the coding blocks of the first video frame segment to the bitstream buffer, wherein the first video frame segment is partitioned into a plurality of column tiles each having at least one tile, the first video encoder starts encoding a second tile of the first video frame segment before encoding of a first tile of the first video frame segment is fully completed, the first tile and the second tile are horizontally adjacent tiles located on opposite sides of a column tile boundary.

According to a fourth aspect of the present invention, an exemplary video encoding method is disclosed. The exemplary video encoding method includes sequentially encoding coding blocks of a first video frame segment in a first encoding order, and outputting encoded data of the coding blocks of the first video frame segment to a bitstream buffer. The first video frame segment is partitioned into a plurality of column tiles each having at least one tile. The first encoding order is identical to an encoding order of encoding a video frame segment with only a single column tile.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first video encoding apparatus according to an embodiment of the present invention.

FIG. 2 is a diagram illustrating a video frame segment with only a single column tile according to an embodiment of the present invention.

FIG. 3 is a diagram illustrating a video frame segment with multiple column tiles according to an embodiment of the present invention.

FIG. 4 is a diagram illustrating video encoding of coding blocks in different tiles according to an embodiment of the present invention.

FIG. 5 is a diagram illustrating an example of applying binary arithmetic coding to a binary sequence {1, 0, 1}.

FIG. 6 is a diagram illustrating a first entropy encoder according to an embodiment of the present invention.

FIG. 7 is a diagram illustrating a second entropy encoder according to an embodiment of the present invention.

FIG. 8 is a diagram illustrating a third entropy encoder according to an embodiment of the present invention.

FIG. 9 is a diagram illustrating a second video encoding apparatus according to an embodiment of the present invention.

FIG. 10 is a diagram illustrating two video frame segments each having multiple column tiles according to an embodiment of the present invention.

FIG. 11 is a diagram illustrating encoding of a video frame segment with multiple column tiles according to the prior art.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

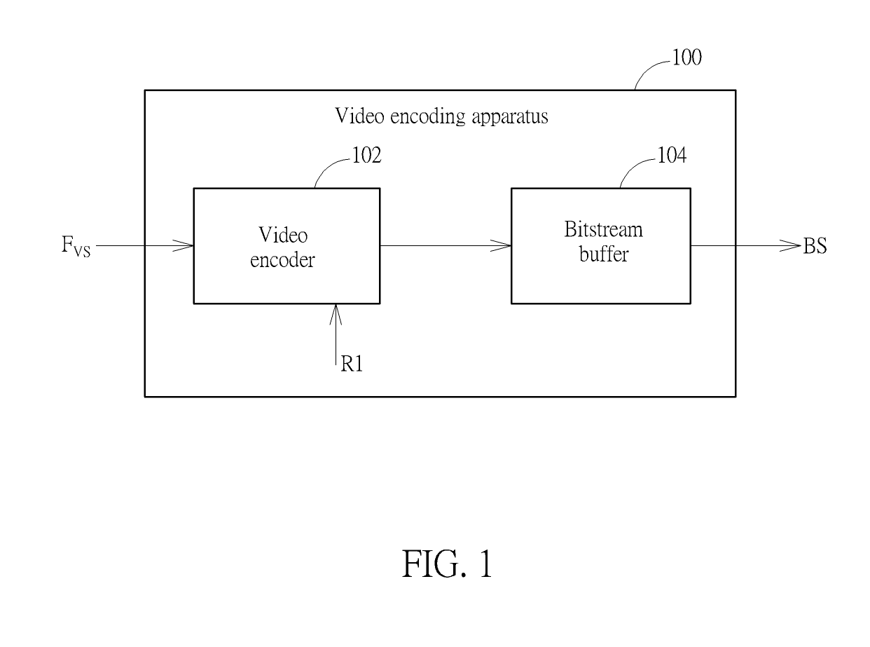

FIG. 1 is a diagram illustrating a first video encoding apparatus according to an embodiment of the present invention. The video encoding apparatus 100 includes a video encoder 102 and a bitstream buffer 104. The video encoder 102 sequentially encodes coding blocks of a video frame segment F_{VS} in a first encoding order R1, and outputs encoded data of the coding blocks of the video frame segment F_{VS} to the bitstream buffer 104. The bitstream buffer 104 may be implemented using an internal storage device, an external storage device, or a combination of an internal storage device and an external storage device. For example, the internal storage device may be a static random access memory (SRAM) or may be flip-flops; and the external storage device may be a dynamic random access memory (DRAM) or may be a flash memory. However, these are for illustrative purposes only, and are not meant to be limitations of the present invention.

In this embodiment, the video frame segment F_{VS} may be one complete video frame to be encoded by a single video encoder, where the video frame segment F_{VS} is partitioned into a plurality of tiles, each of the tiles includes a plurality of coding blocks (which are basic processing units of video encoding), and each of the coding blocks includes a plurality of pixels. A coding block is a basic processing unit according to a video coding standard. For example, when the video coding standard employed by the video encoder 102 is VP9, one coding block is one super block (SB). For another example, when the video coding standard employed by the video encoder 102 is HEVC (High Efficiency Video Coding), one coding block is one coding tree unit (CTU) (also referred to as one largest coding unit (LCU)). In accordance with a conventional encoding order specified by the video coding standard (e.g., VP9 or HEVC), tiles in one video frame are encoded in a raster scan order, and coding blocks in one tile are encoded in a raster scan order. However, as mentioned in the above background section, a video encoder using such a conventional encoding order suffers from buffer bandwidth overhead, higher buffer cost and larger chip area. To address these issues, the present invention therefore proposes using a new encoding order that is different from the conventional encoding order. For example, when the video frame segment F_{VS} is partitioned into a plurality of column tiles each having at least one tile, the first encoding order R1 employed by the video encoder 102 is identical to an encoding order R2 of encoding a video frame segment with only a single column tile.

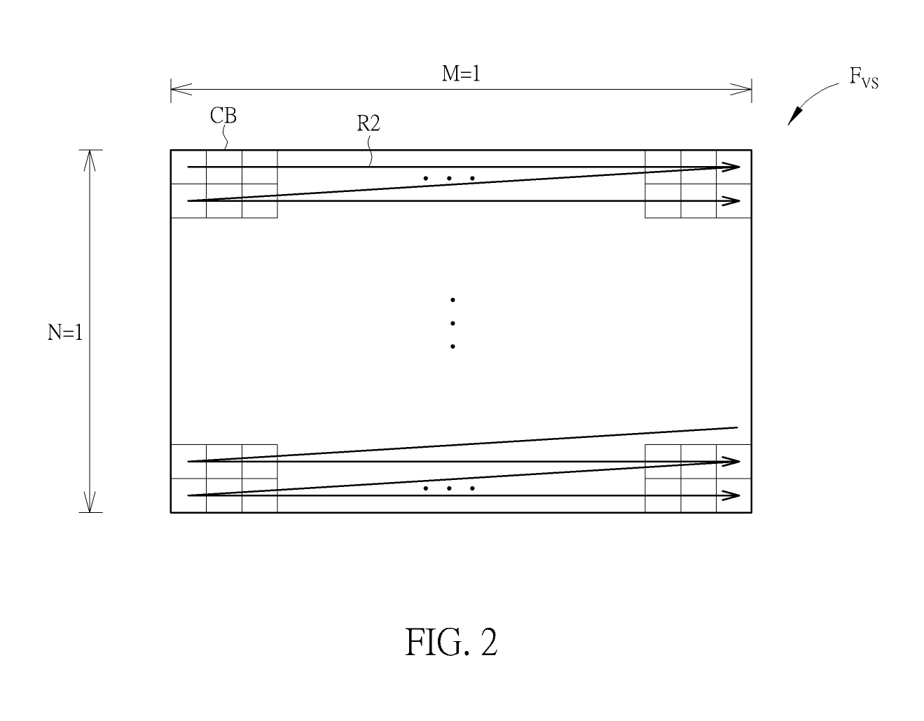

FIG. 2 is a diagram illustrating a video frame segment with only a single column tile according to an embodiment of the present invention. In this example, the number of column tiles M in the video frame segment F_{VS} is equal to 1 (i.e., M=1), and the number of row tiles N in the video frame segment F_{VS} is equal to 1 (i.e., N=1). Hence, the exemplary video frame segment F_{VS} shown in FIG. 2 may be regarded as having a single tile. As shown in FIG. 2, the video frame segment F_{VS} includes a plurality of coding blocks CB (e.g., SBs for VP9 or CTUs/LCUs for HEVC) each having a plurality of pixels, and the coding blocks CB in the video frame segment F_{VS} are encoded in an encoding order R2 (e.g., a raster scan order). Hence, coding blocks in the same coding block row are sequentially encoded from a left-most coding block to a right-most coding block, and coding block rows in the video frame segment F_{VS} are sequentially encoded from a top-most coding block to a bottom-most coding block row.

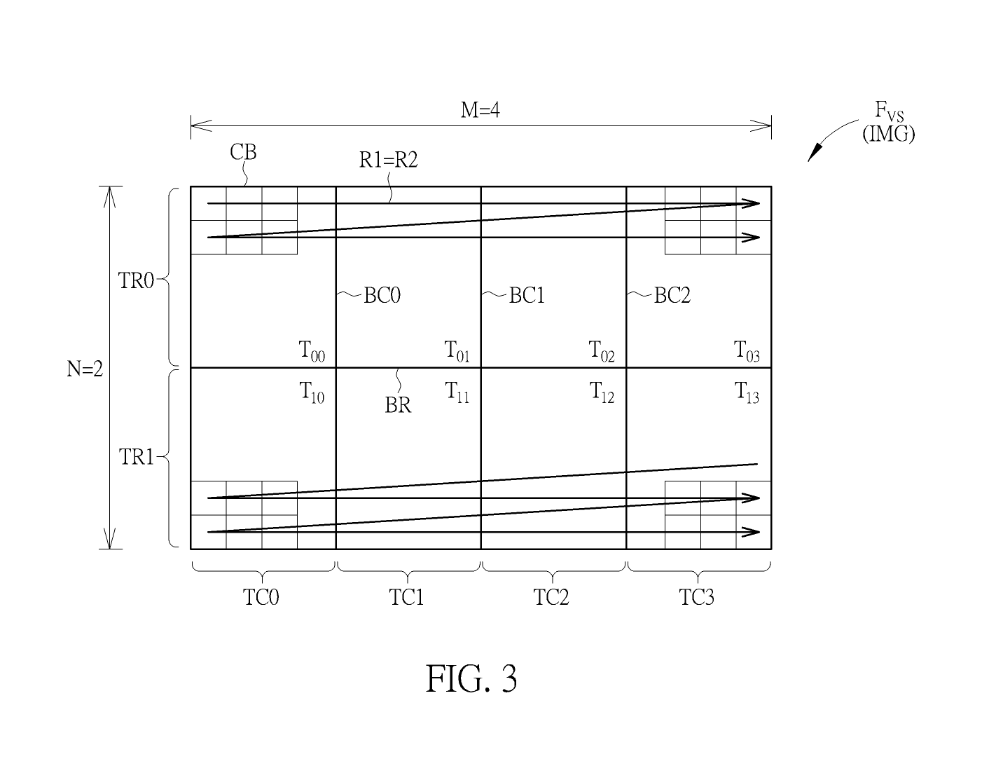

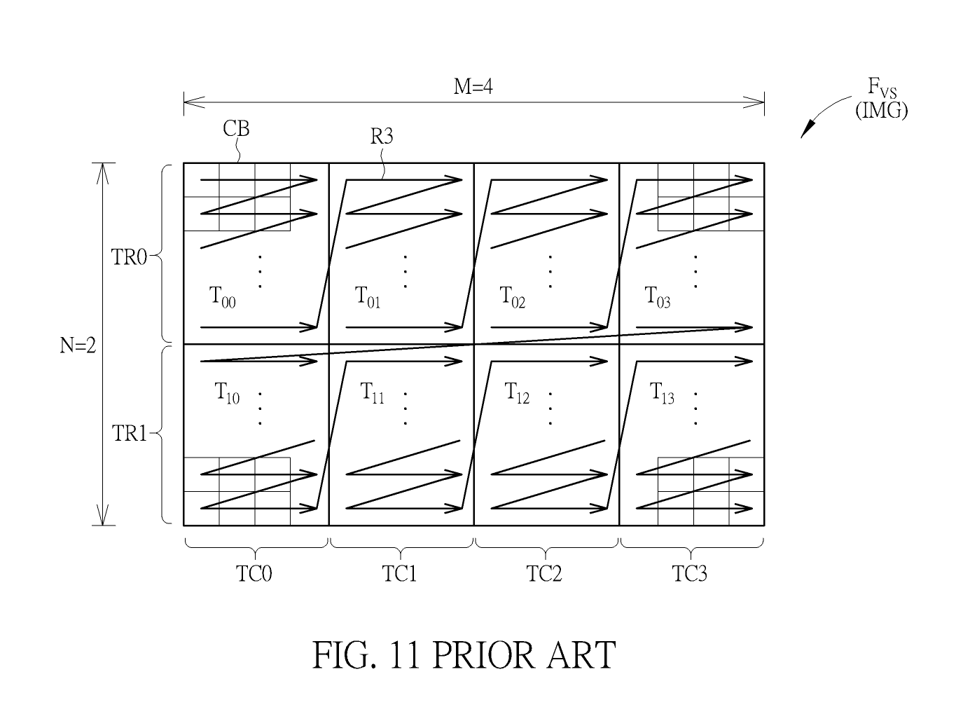

FIG. 3 is a diagram illustrating a video frame segment with multiple column tiles according to an embodiment of the present invention. In this example, the video frame segment F_{VS} is one complete video frame IMG, and the number of column tiles M in the video frame segment F_{VS} is equal to 4 (i.e., M=4), and the number of row tiles N in the video frame segment F_{VS} is equal to 2 (i.e., N=2). Hence, the exemplary video frame segment F_{VS} shown in FIG. 3 has 2×4 tiles T₀₀, T₀₁, T₀₂, T₀₃, T₁₀, T₁₁, T₁₂, T₁₃. The column tile TC0 includes two tiles T₀₀ and T₁₀ arranged vertically. The column tile TC1 includes two tiles T₀₁ and T₁₁ arranged vertically. The column tile TC2 includes two tiles T₀₂ and T₁₂ arranged vertically. The column tile TC3 includes two tiles T₀₃ and T₁₃ arranged vertically. Adjacent column tiles TC0 and TC1 are located on opposite sides of a column tile boundary (i.e., vertical tile boundary) BC0. Adjacent column tiles TC1 and TC2 are located on opposite sides of a column tile boundary (i.e., vertical tile boundary) BC1. Adjacent column tiles TC2 and TC3 are located on opposite sides of a column tile boundary (i.e., vertical tile boundary) BC2. The row tile TR0 includes four tiles T₀₀, T₀₁, T₀₂, T₀₃ arranged horizontally. The row tile TR1 includes four tiles T₁₀, T₁₁, T₁₂, T₁₃ arranged horizontally. Adjacent row tiles TR0 and TR1 are located on opposite of a row tile boundary (i.e., horizontal tile boundary) BR. Though the video frame segment F_{VS} (e.g., one complete video frame IMG) is partitioned into multiple column tiles each having multiple tiles, coding blocks CB (e.g., SBs for VP9 or CTUs/LCUs for HEVC) of the video frame segment F_{VS} are encoded by the video encoder 102 in the first encoding order R1 that is identical to the encoding order R2 of encoding the video frame segment F_{VS} with only a single column tile as illustrated in FIG. 2. As can be readily seen from FIG. 3 and FIG. 11, the first encoding order R1 is different from the conventional encoding order R3 which specifies a raster scan order for encoding tiles in one video frame segment and a raster scan order for encoding coding blocks in one tile.

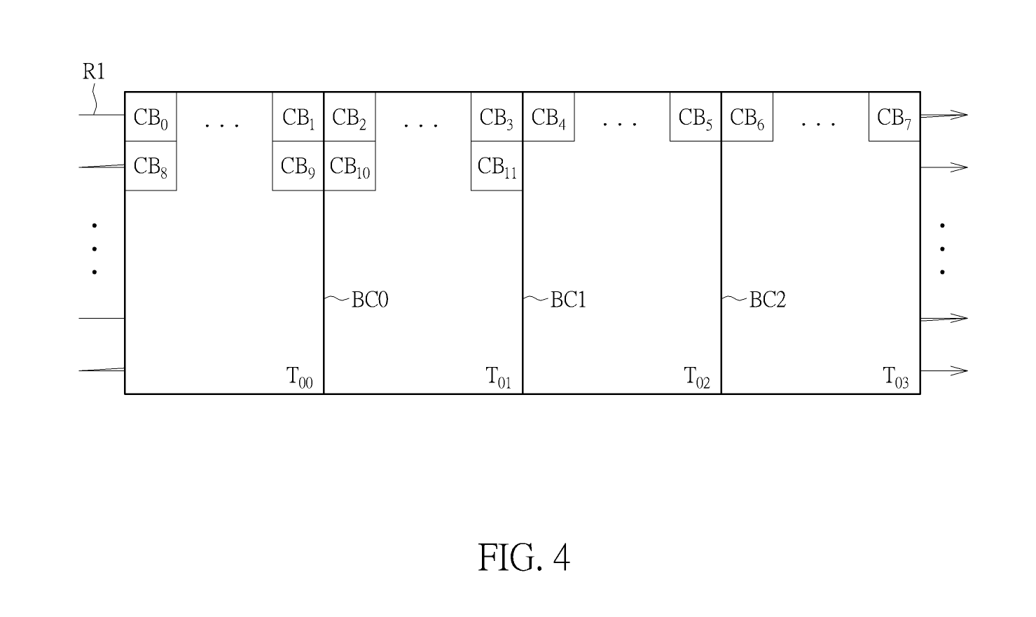

Since the video encoder 102 employs the first encoding order R1 to encode coding blocks in the video frame segment F_{VS}, coding blocks in the same tile are not encoded continuously. FIG. 4 is a diagram illustrating video encoding of coding blocks in different tiles according to an embodiment of the present invention. For clarity and simplicity, only top four tiles T₀₀, T₀₁, T₀₂, T₀₃ belonging to different column tiles are illustrated. A left-most coding block and a right-most coding block at the first coding block row of the tile T₀₀ are denoted by CB₀ and CB₁, respectively, and a left-most coding block and a right-most coding block at the second coding block row of the tile T₀₀ are denoted by CB₈ and CB₉, respectively. A left-most coding block and a right-most coding block at the first coding block row of the tile T₀₁ are denoted by CB₂ and CB₃, respectively, and a left-most coding block and a right-most coding block at the second coding block row of the tile T₀₁ are denoted by CB₁₀ and CB₁₁, respectively. A left-most coding block and a right-most coding block at the first coding block row of the tile T₀₂ are denoted by CB₄ and CB₅, respectively. A left-most coding block and a right-most coding block at the first coding block row of the tile T₀₃ are denoted by CB₆ and CB₇, respectively.

In accordance with the first encoding order R1, the video encoder 102 starts encoding the video frame segment V_{FS} by encoding the coding block CB₀ of the tile T₀₀. When the coding block CB₁ has been encoded, the video encoder 102 encounters the column tile boundary BC0, such that encoding of the first coding block row of the tile T₀₀ is done.

Tiles T₀₀ and T₀₁ are horizontally adjacent tiles located on opposite sides of the column tile boundary BC0 encountered by the video encoder 102. In accordance with the first encoding order R1, the video encoder 102 pauses encoding of the tile T₀₀, and starts encoding the tile T₀₁ by encoding the coding block CB₂. When the coding block CB₃ has been encoded, the video encoder 102 encounters the column tile boundary BC1, such that encoding of the first coding block row of the tile T₀₁ is done.

Tiles T₀₁ and T₀₂ are horizontally adjacent tiles located on opposite sides of the column tile boundary BC1 encountered by the video encoder 102. In accordance with the first encoding order R1, the video encoder 102 pauses encoding of the tile T₀₁, and starts encoding the tile T₀₂ by encoding the coding block CB₄. When the coding block CB₅ has been encoded, the video encoder 102 encounters the column tile boundary BC2, such that encoding of the first coding block row of the tile T₀₂ is done.

Tiles T₀₂ and T₀₃ are horizontally adjacent tiles located on opposite sides of the column tile boundary BC2 encountered by the video encoder 102. In accordance with the first encoding order R1, the video encoder 102 pauses encoding of the tile T₀₂, and starts encoding the tile T₀₃ by encoding the coding block CB₆. When the coding block CB₇ has been encoded, encoding of the first coding block row of the tile T₀₃ is done. This also means that the first coding block row of the video frame segment V_{FS} has been encoded.

When the first coding block row of the video frame segment V_{FS} has been encoded, the video encoder 102 resumes encoding of the tile T₀₀ by encoding the coding block CB₈. When the coding block CB₉ has been encoded, the video encoder 102 encounters the column tile boundary BC0 again, such that encoding of the second coding block row of the tile T₀₀ is done. In accordance with the first encoding order R1, the video encoder 102 pauses encoding of the tile T₀₀, and resumes encoding of the tile T₀₁ by encoding the coding block CB₁₀. When the coding block CB₁₁ has been encoded, the video encoder 102 encounters the column tile boundary BC1 again, such that encoding of the second coding block row of the tile T₀₁ is done.

Since a person skilled in the pertinent art can readily understand the following video encoding process of the rest of the coding blocks in the tiles T₀₀, T₀₁, T₀₂, T₀₃ after reading above paragraphs, further description is omitted here for brevity.

To put it simply, in accordance with the first encoding order R1, adjacent coding blocks (e.g., CB₁ and CB₂) located at the same coding block row of the video frame segment V_{FS} and located on opposite sides of a column tile boundary (e.g., BC0) are encoded by the video encoder 102 sequentially. In addition, the video encoder 102 starts encoding a second tile (e.g., T₀₁) of the video frame segment V_{FS} before encoding of a first tile (e.g., T₀₀) of the video frame segment V_{FS} is fully completed, where the first tile and the second tile are horizontally adjacent tiles located on opposite sides of a column tile boundary (e.g., BC0).

When a coding block is encoded under an inter prediction mode, reference pixels in a search window are required to be loaded from a reference frame buffer to a local buffer of a video encoder for motion estimation. A search window of motion estimation of a coding block located on a left side of a column tile boundary may overlap a search window of motion estimation of an adjacent coding block located on a right side of the column tile boundary. Since adjacent coding blocks (e.g., CB₁ and CB₂) located at the same coding block row of the video frame segment V_{FS} and located on opposite sides of a column tile boundary (e.g., BC0) are encoded by the video encoder 102 sequentially, some of the reference pixels loaded into the local buffer of the video encoder 102 for motion estimation of the current coding block (e.g., CB₁) located on the left side of the column tile boundary (e.g., BC0) can be reused for motion estimation of the next coding block (e.g., CB₂) located on the right side of the column tile boundary (e.g., BC0) due to spatial continuity under the first encoding order R1. In this way, the buffer bandwidth overhead of the reference frame buffer can be reduced or avoided.

Further, consider a case where a deblocking filter is used as an in-loop filter of the video encoder 102. Since adjacent coding blocks (e.g., CB₁ and CB₂) located at the same coding block row of the video frame segment V_{FS} and located on opposite sides of a column tile boundary (e.g., BC0) are encoded by the video encoder 102 sequentially according to the first encoding order R1, reconstructed pixels of some pixel columns in the coding block (e.g., CB₂) located on the left side of a column tile boundary (e.g., BC0) may still be available in the local buffer of the video encoder 102 when reconstructed pixels of some pixel columns in the coding block (e.g., CB₂) located on the right side of the tile boundary (e.g., BC0) are obtained by the video encoder 102. In this way, when reconstructed pixels of some pixel columns in the coding block (e.g., CB₂) located on the right side of the tile boundary (e.g., BC0) are obtained by the video encoder 102, the video encoder 102 can perform deblocking filtering without using an additional column buffer to store reconstructed pixels of some pixel columns in the coding block (e.g., CB₁) located on the left side of the column tile boundary (e.g., BC0), thus reducing the buffer cost as well as the chip area.

It should be noted that, when the first encoding order R1 is employed by the video encoder 102, the buffer bandwidth (e.g., DRAM bandwidth) and the power consumption are not affected by the number of column tiles in one video frame segment. That is, when the number of column tiles in one video frame segment is increased, the buffer bandwidth (e.g., DRAM bandwidth) and the power consumption may have no increment or may have an almost negligible increment.

As mentioned above, when the first encoding order R1 is employed by the video encoder 102, encoding of a second tile (e.g., T₀₁) of the video frame segment F_{VS} is started before encoding of a first tile (e.g., T₀₀) of the video frame segment F_{VS} is fully completed. Hence, encoding of one tile is performed by the video encoder 102 intermittently. Specifically, different coding block rows in the same tile are encoded by the video encoder 102 during discontinuous time periods. However, to obtain a bitstream of one tile, coding blocks in the same tile should be encoded in a raster scan order. When binary arithmetic coding (e.g., context-adaptive binary arithmetic coding (CABAC)) is a method of entropy encoding used in the video encoder 102 (e.g., VP9 encoder or HEVC encoder), an entropy encoding status of a tile is needed to be stored at the time the video encoder 102 pauses encoding of the tile, and the stored entropy encoding status of the tile is needed to be loaded at the time the video encoder 102 resumes encoding of the tile. For example, when encoding of the tile T₀₀ is paused due to an end of encoding the coding block CB₁, an entropy encoding status at the location of the coding block CB₁ is stored, and when encoding of the tile T₀₀ is resumed due to a start of encoding the coding block CB₈ (which is the next coding block of the coding block CB₁ according to the raster scan order in the tile T₀₀), the stored entropy encoding status is loaded for encoding the coding block CB₈. Similarly, when encoding of the tile T₀₁ is paused due to an end of encoding the coding block CB₃, an entropy encoding status at the location of the coding block CB₃ is stored, and when encoding of the tile T₀₁ is resumed due to a start of encoding the coding block CB₁₀ (which is the next coding block of the coding block CB₃ according to the raster scan order in the tile T₀₁), the stored entropy encoding status is loaded for encoding the coding block CB₁₀.

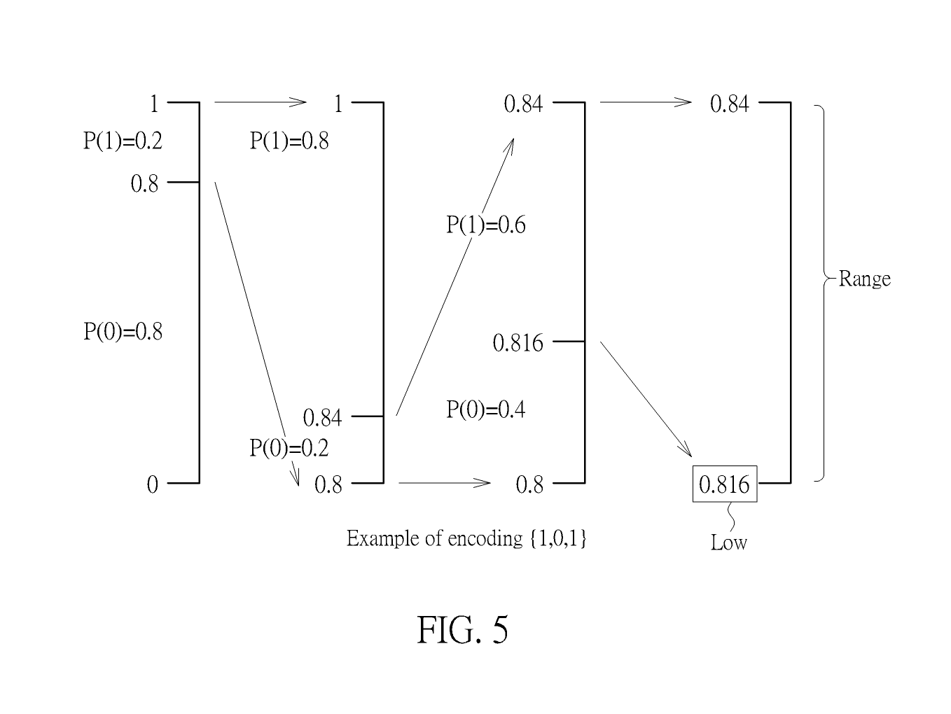

FIG. 5 is a diagram illustrating an example of applying binary arithmetic coding to a binary sequence {1, 0, 1}. The binary arithmetic coding encodes the binary sequence into a single number under a given probability model. Before anything is transmitted, the range for the binary sequence is the entire interval [0, 1). As each binary symbol/bin is processed, the range is narrowed to a portion of it that is allocated to the binary symbol/bin. In this example, the probability model is P(1)={0.2, 0.8, 0.6} and P(0)={0.8, 0.2, 0.4}. In VP9, the same probability model is used in encoding of different tiles within the same video frame. However, in HEVC, each tile has its own probability model that will be updated during encoding of the tile. For example, the probability model used for encoding the coding block CB₀ in the tile T₀₀ is P(1)={0.2, 0.8, 0.6} and P(0)={0.8, 0.2, 0.4}, and the probability model used for encoding the coding block CB₁ in the same tile T₀₀ is P(1)={0.1, 0.4, 0.8} and P(0)={0.9, 0.6, 0.2}. Hence, the content of the stored entropy encoding status depends on the video coding standard employed by the video encoder 102. In a case where the video encoder 102 is a VP9 encoder, the stored entropy encoding status may include a Low value and a Range value. In another case where the video encoder 102 is an HEVC encoder, the stored entropy encoding status may include a Low value, a Range value, and probability model information.

Entropy encoding of one tile may be independent of entropy encoding of another tile. Hence, each tile has its own entropy encoding status maintained during encoding of the tile. The video encoder 102 may employ a proper entropy encoding design to meet the requirement under a condition that coding blocks in a video frame segment (which is partitioned into multiple column tiles) are sequentially encoded in the first encoding order R1 that is identical to the encoding order (e.g., raster scan order) R2 of encoding a video frame segment with only a single column tile.

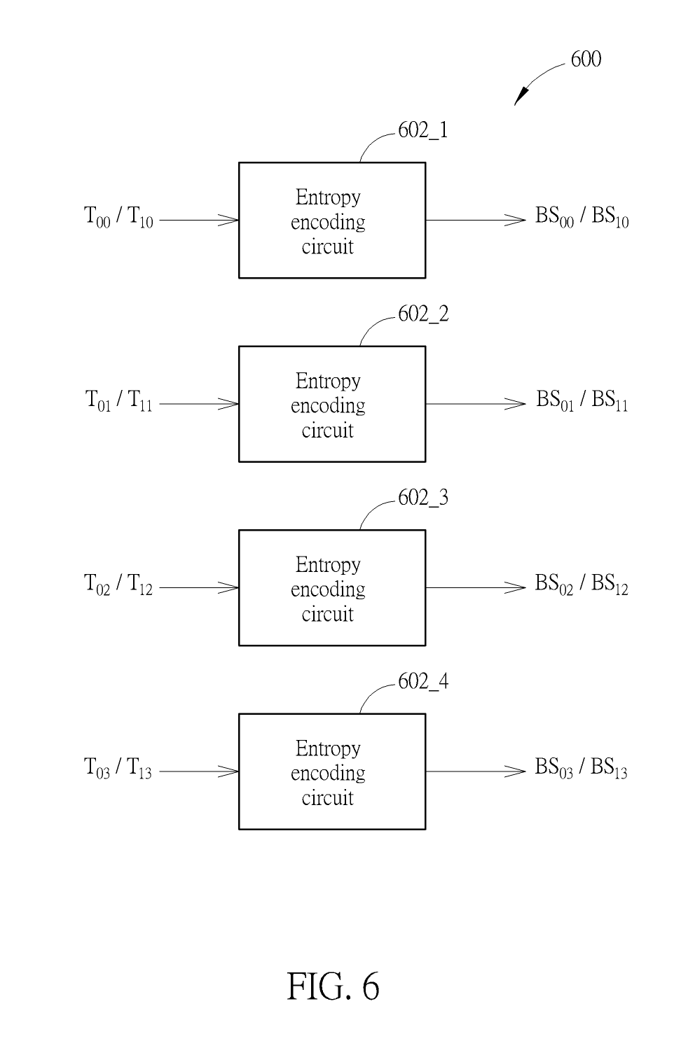

FIG. 6 is a diagram illustrating a first entropy encoder according to an embodiment of the present invention. The entropy encoder 600 may be a part of the video encoder 102. In this embodiment, multiple entropy encoding circuits are implemented in the entropy encoder 600, where the number of separate entropy encoding circuits implemented in the entropy encoder 600 is equal to the number of column tiles defined in the video frame segment V_{FS}. In a case where the video frame segment V_{FS} is partitioned into four column tiles TC0, TC1, TC2, TC3 as shown in FIG. 3, the entropy encoder 600 is configured to have four entropy encoding circuits 602_1, 602_2, 602_3, 602_4 used to apply entropy encoding to the column tiles TC0, TC1, TC2, TC3, respectively. Hence, the entropy encoding circuit 602_1 is used to entropy encode information (e.g., transform coefficient information) of the tile T₀₀ into a bitstream BS₀₀, and is reused to entropy encode information (e.g., transform coefficient information) of the tile T₁₀ into a bitstream BS₁₀; the entropy encoding circuit 602_2 is used to entropy encode information (e.g., transform coefficient information) of the tile T₀₁ into a bitstream BS₀₁, and is reused to entropy encode information (e.g., transform coefficient information) of the tile T₁₁ into a bitstream BS₁₁; the entropy encoding circuit 602_3 is used to entropy encode information (e.g., transform coefficient information) of the tile T₀₂ into a bitstream BS₀₂, and is reused to entropy encode information (e.g., transform coefficient information) of the tile T₁₂ into a bitstream BS₁₂; and the entropy encoding circuit 602_4 is used to entropy encode information (e.g., transform coefficient information) of the tile T₀₃ into a bitstream BS₀₃, and is reused to entropy encode information (e.g., transform coefficient information) of the tile T₁₃ into a bitstream BS₁₃.

In addition, the entropy encoding circuit 602_1 has a local buffer (not shown) that buffers an entropy encoding status of the tile T₀₀ during encoding of the tile T₀₀ and buffers an entropy encoding status of the tile T₁₀ during encoding of the tile T₁₀; the entropy encoding circuit 602_2 has a local buffer (not shown) that buffers an entropy encoding status of the tile T₀₁ during encoding of the tile T₀₁ and buffers an entropy encoding status of the tile T₁₁ during encoding of the tile T₁₁; the entropy encoding circuit 602_3 has a local buffer (not shown) that buffers an entropy encoding status of the tile T₀₂ during encoding of the tile T₀₂ and buffers an entropy encoding status of the tile T₁₂ during encoding of the tile T₁₂; and the entropy encoding circuit 602_4 has a local buffer (not shown) that buffers an entropy encoding status of the tile T₀₃ during encoding of the tile T₀₃ and buffers an entropy encoding status of the tile T₁₃ during encoding of the tile T₁₃.

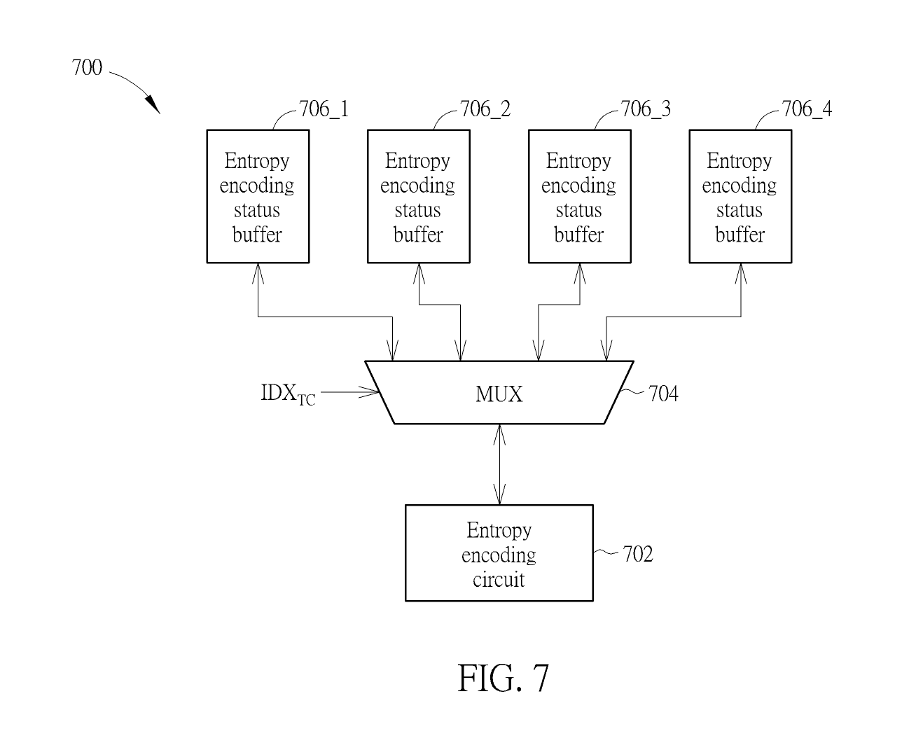

FIG. 7 is a diagram illustrating a second entropy encoder according to an embodiment of the present invention. The entropy encoder 700 may be a part of the video encoder 102. In this embodiment, a single entropy encoding circuit and multiple entropy encoding status buffers are implemented in the entropy encoder 700, where the number of separate entropy encoding status buffers implemented in the entropy encoder 700 is equal to the number of column tiles defined in the video frame segment V_{FS}. In a case where the video frame segment V_{FS} is partitioned into four column tiles TC0, TC1, TC2, TC3 as shown in FIG. 3, the entropy encoder 700 is configured to have one entropy encoding circuit 702 and four entropy encoding status buffers 706_1, 706_2, 706_3, 706_4. The entropy encoding circuit 702 is used to apply entropy encoding to the column tiles TC0, TC1, TC2, TC3, sequentially and cyclically.

The first encoding order R1 defines that coding block rows with the same row index in different column tiles TC0, TC1, TC2, TC3 are encoded continuously, and coding block rows with different row indices in the same column tile TC0/TC1/TC2/TC3 are encoded discontinuously. Since the same entropy encoding circuit 702 is shared by entropy encoding of different column tiles TC0, TC1, TC2, TC3, the entropy encoding circuit 702 stores entropy encoding statuses associated with entropy encoding of the column tiles TC0, TC1, TC2, TC3 into respective entropy encoding status buffers 706_1, 706_2, 706_3, 706_4, and loads the entropy encoding statuses associated with entropy encoding of the column tiles TC0, TC1, TC2, TC3 from respective entropy encoding status buffers 706_1, 706_2, 706_3, 706_4.

As shown in FIG. 7, a multiplexer (MUX) 704 is coupled between the entropy encoding status buffers 706_1-706_4 and the entropy encoding circuit 702, and is controlled by a column tile index IDX_{TC}. When the first encoding order R1 indicates that a portion of a tile to be encoded is located in a column tile with a column tile index IDX_{TC}, the multiplexer 704 couples the entropy encoding circuit 702 to an entropy encoding status buffer allocated for the column tile with the column tile index IDX_{TC}. For example, when IDX_{TC}=0, the multiplexer 704 couples the entropy encoding circuit 702 to the entropy encoding status buffer 706_1; when IDX_{TC}=1, the multiplexer 704 couples the entropy encoding circuit 702 to the entropy encoding status buffer 706_2; when IDX_{TC}=2, the multiplexer 704 couples the entropy encoding circuit 702 to the entropy encoding status buffer 706_3; and when IDX_{TC}=3, the multiplexer 704 couples the entropy encoding circuit 702 to the entropy encoding status buffer 706_4.

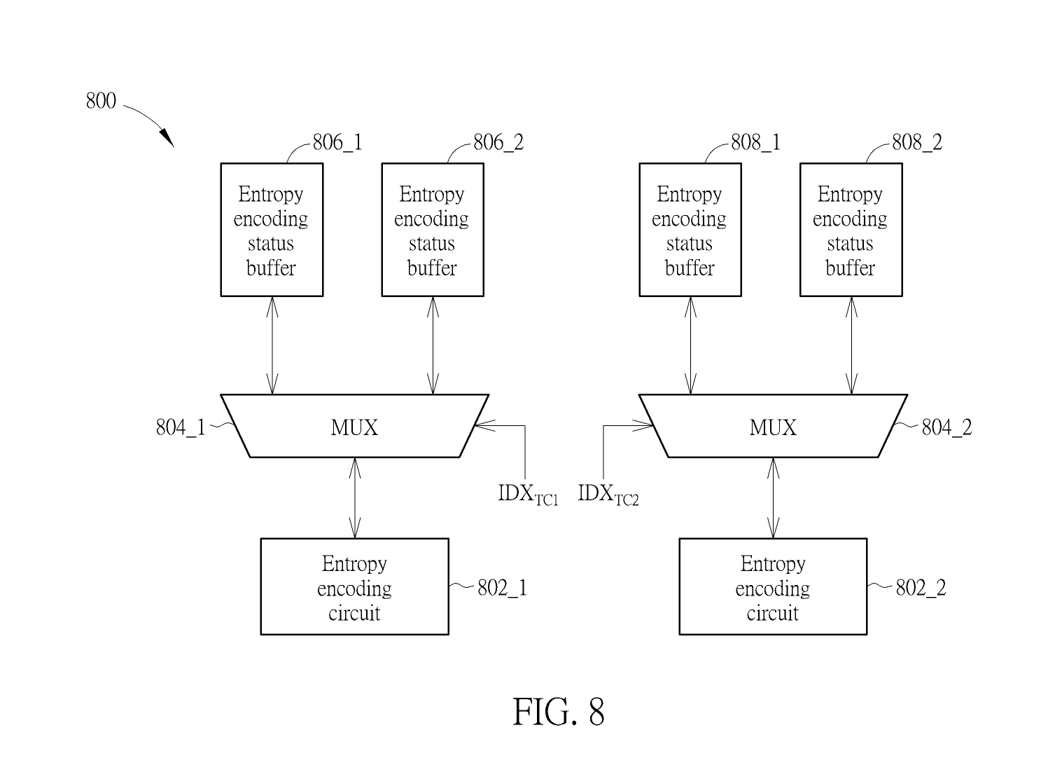

FIG. 8 is a diagram illustrating a third entropy encoder according to an embodiment of the present invention. The entropy encoder 800 may be apart of the video encoder 102. In this embodiment, multiple entropy encoding circuits and multiple entropy encoding status buffers are implemented in the entropy encoder 800, where the number of separate entropy encoding circuits implemented in the entropy encoder 800 is smaller than the number of column tiles defined in the video frame segment V_{FS}, and the number of separate entropy encoding status buffers implemented in the entropy encoder 800 is equal to the number of column tiles defined in the video frame segment V_{FS}. In a case where the video frame segment V_{FS} is partitioned into four column tiles TC0, TC1, TC2, TC3 as shown in FIG. 3, the entropy encoder 800 is configured to have two entropy encoding circuits 802_1 and 802_2 and four entropy encoding status buffers 806_1, 806_2, 808_1, 808_2. The entropy encoding circuit 802_1 is used to apply entropy encoding to a portion of the column tiles TC0, TC1, TC2, TC3, sequentially and cyclically. The entropy encoding circuit 802_2 is used to apply entropy encoding to a remaining portion of the column tiles TC0, TC1, TC2, TC3, sequentially and cyclically. For example, the entropy encoding circuit 802_1 applies entropy encoding to column tiles TC0 and TC1, sequentially and cyclically, and the entropy encoding circuit 802_2 applies entropy encoding to column tiles TC2 and TC3, sequentially and cyclically.

The first encoding order R1 defines that coding block rows with the same row index in different column tiles TC0, TC1, TC2, TC3 are encoded continuously, and coding block rows with different row indices in the same column tile TC0/TC1/TC2/TC3 are encoded discontinuously. Since the same entropy encoding circuit 802_1 is shared by entropy encoding of different column tiles TC0 and TC1, the entropy encoding circuit 802_1 stores entropy encoding statuses associated with entropy encoding of the column tiles TC0 and TC1 into respective entropy encoding status buffers 806_1 and 806_2, and loads the entropy encoding statuses associated with entropy encoding of the column tiles TC0 and TC1 from respective entropy encoding status buffers 806_1 and 806_2. Since the same entropy encoding circuit 802_2 is shared by entropy encoding of different column tiles TC2 and TC3, the entropy encoding circuit 802_2 stores entropy encoding statuses associated with entropy encoding of the column tiles TC2 and TC3 into respective entropy encoding status buffers 808_1 and 808_2, and loads the entropy encoding statuses associated with entropy encoding of the column tiles TC2 and TC3 from respective entropy encoding status buffers 808_1 and 808_2.

As shown in FIG. 8, a multiplexer (MUX) 804_1 is coupled between the entropy encoding status buffers 806_1, 806_2 and the entropy encoding circuit 802_1, and is controlled by a column tile index IDX_{TC1}; and a multiplexer (MUX) 804_2 is coupled between the entropy encoding status buffers 808_1, 808_2 and the entropy encoding circuit 802_2, and is controlled by a column tile index IDX_{TC2}. Suppose that the entropy encoding circuit 802_1 is shared by entropy encoding of column tiles TC0 and TC1, and the entropy encoding circuit 802_2 is shared by entropy encoding of column tiles TC2 and TC3. Hence, the column tile index IDX_{TC1} is either 0 or 1, and the column tile index IDX_{TC2} is either 2 or 3.

When the first encoding order R1 indicates that a portion of a tile to be encoded is located in a column tile with a column tile index IDX_{TC1}, the multiplexer 804_1 couples the entropy encoding circuit 802_1 to an entropy encoding status buffer allocated for the column tile with the column tile index IDX_{TC1}. For example, when IDX_{TC1}=0, the multiplexer 804_1 couples the entropy encoding circuit 802_1 to the entropy encoding status buffer 806_1; and when IDX_{TC1}=1, the multiplexer 804_1 couples the entropy encoding circuit 802_1 to the entropy encoding status buffer 806_2.

When the first encoding order R1 indicates that a portion of a tile to be encoded is located in a column tile with a column tile index IDX_{TC2}, the multiplexer 804_2 couples the entropy encoding circuit 802_2 to an entropy encoding status buffer allocated for the column tile with the column tile index IDX_{TC2}. For example, when IDX_{TC2}=2, the multiplexer 804_2 couples the entropy encoding circuit 802_2 to the entropy encoding status buffer 808_1; and when IDX_{TC2}=3, the multiplexer 804_2 couples the entropy encoding circuit 802_2 to the entropy encoding status buffer 808_2.

As mentioned above, the bitstream buffer 104 is used to buffer encoded data generated from encoding coding blocks in the video frame segment V_{FS} in the first encoding order R1. However, the first encoding order R1 is different from the conventional encoding order (e.g., R3 shown in FIG. 11) which specifies a raster scan order for encoding tiles in one video frame segment and a raster scan order for encoding coding blocks in one tile. The encoded data stored in the bitstream buffer 104 may be properly read and concatenated to form an encoded bitstream BS with encoded data arranged in a transmission order matching the conventional encoding order (e.g., R3 shown in FIG. 11).

In above example, a video frame segment may be a complete video frame that is partitioned into multiple column tiles and is encoded using a single video encoder (e.g., video encoder 102 shown in FIG. 1). However, this is for illustrative purposes only, and is not meant to be a limitation of the present invention. In an alternative design, a video frame segment may be a partial video frame, and multiple video frame segments may be encoded using multiple video encoders, respectively.

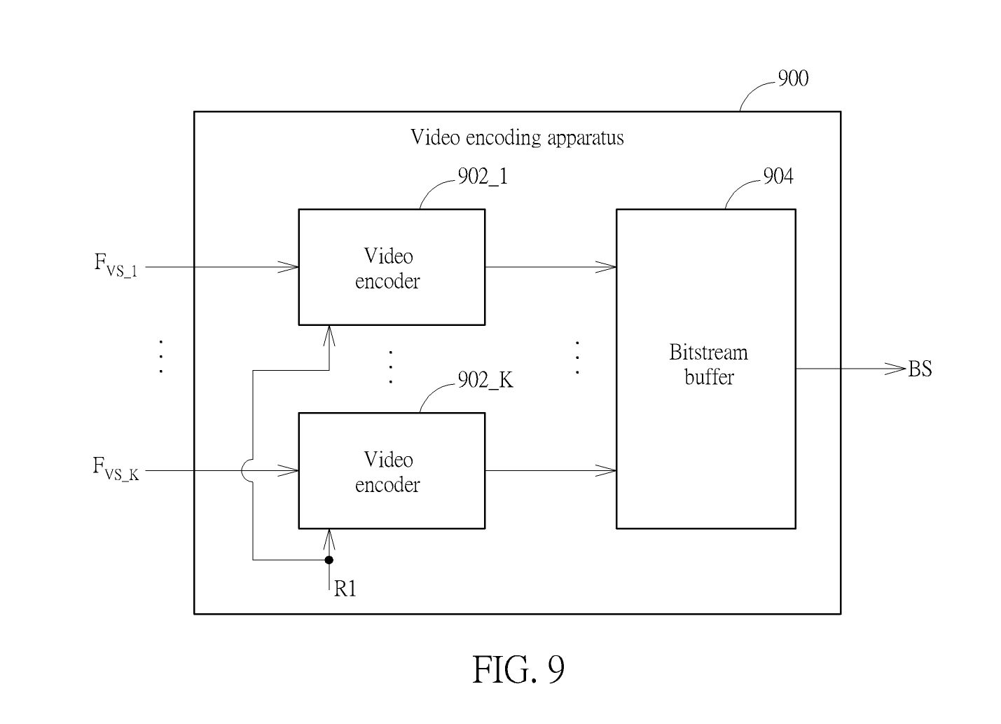

FIG. 9 is a diagram illustrating a second video encoding apparatus according to an embodiment of the present invention. The video encoding apparatus 900 includes a plurality of video encoders 902_1-902_K and a bitstream buffer 904, where K is a positive integer not smaller than 2. The bitstream buffer 904 may be implemented using an internal storage device, an external storage device, or a combination of an internal storage device and an external storage device. For example, the internal storage device may be a static random access memory (SRAM) or may be flip-flops; and the external storage device may be a dynamic random access memory (DRAM) or may be a flash memory. However, these are for illustrative purposes only, and are not meant to be limitations of the present invention.

In this embodiment, one complete video frame is composed of a plurality of video frame segments F_{VS}_{_}₁-F_{VS}_{_}_{K}. Each of the video frame segments F_{VS}_{_}₁-F_{VS}_{_}_{K} is partitioned into a plurality of tiles, where each of the tiles includes a plurality of coding blocks (which are basic processing units of video encoding), and each of the coding blocks includes a plurality of pixels. For example, each of the video frame segments F_{VS}_{_}₁-F_{VS}_{_}_{K} is partitioned into a plurality of column tiles each having at least one tile.

In addition, the video frame segments F_{VS}_{_}₁-F_{VS}_{_}_{K} are encoded using the video encoders 902_1-902_K, respectively. Hence, each of the video encoders 902_1-902_K sequentially encodes coding blocks of a video frame segment in the first encoding order R1, and outputs encoded data of the coding blocks of the video frame segment to the bitstream buffer 904. As mentioned above, the first encoding order R1 is identical to the encoding order R2 of encoding a video frame segment with only a single column tile. In addition, the encoded data stored in the bitstream buffer 904 may be properly read and concatenated to form an encoded bitstream BS with encoded data arranged in a transmission order matching the conventional encoding order (e.g., R3 shown in FIG. 11).

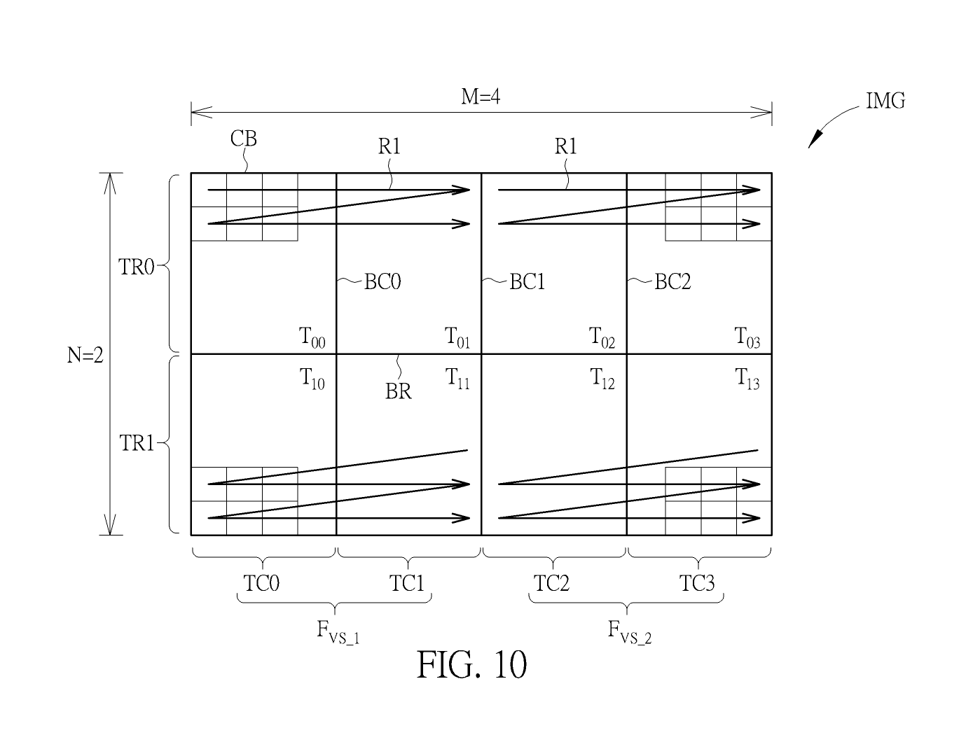

Considering a case where K=2, a video frame segment F_{VS}_{_}₁ is a first part of a complete video frame that is encoded using a video encoder 902_1, and a video frame segment F_{VS}_{_}₂ is a second part of the complete video frame that is encoded using a video encoder 902_K (K=2). FIG. 10 is a diagram illustrating two video frame segments each having multiple column tiles according to an embodiment of the present invention. In this example, each of the video frame segments F_{VS}_{_}₁ and F_{VS}_{_}₂ is a partial video frame (i.e., a part of one complete video frame IMG), the number of column tiles M in the complete video frame IMG is equal to 4 (i.e., M=4), and the number of row tiles N in the complete video frame IMG is equal to 2 (i.e., N=2). The column tile TC0 includes two tiles T₀₀ and T₁₀ arranged vertically. The column tile TC1 includes two tiles T₀₁ and T₁₁ arranged vertically. The column tile TC2 includes two tiles T₀₂ and T₁₂ arranged vertically. The column tile TC3 includes two tiles T₀₃ and T₁₃ arranged vertically. Adjacent column tiles TC0 and TC1 are located on opposite sides of a column tile boundary (i.e., vertical tile boundary) BC0. Adjacent column tiles TC1 and TC2 are located on opposite sides of a column tile boundary (i.e., vertical tile boundary) BC1. Adjacent column tiles TC2 and TC3 are located on opposite sides of a column tile boundary (i.e., vertical tile boundary) BC2. The row tile TR0 includes four tiles T₀₀, T₀₁, T₀₂, T₀₃ arranged horizontally. The row tile TR1 includes four tiles T₁₀, T₁₁, T₁₂, T₁₃ arranged horizontally. Adjacent row tiles TR0 and TR1 are located on opposite of a row tile boundary (i.e., horizontal tile boundary) BR.

As shown in FIG. 10, the exemplary video frame segment F_{VS}_{_}₁ has 2×2 tiles T₀₀, T₀₁, T₁₀, T₁₁, and the exemplary video frame segment F_{VS}_{_}₂ has 2×2 tiles T₀₂, T₀₃, T₁₂, T₁₃. Though each of the video frame segments (e.g., partial video frames) F_{VS}_{_}₁ and F_{VS}_{_}₂ is partitioned into multiple column tiles each having multiple tiles, coding blocks CB (e.g., SBs for VP9 or CTUs/LCUs for HEVC) of the video frame segment F_{VS}_{_}₁ are encoded by the video encoder 902_1 in the first encoding order R1 that is identical to the encoding order R2 of encoding the video frame segment F_{VS} with only a single column tile as illustrated in FIG. 2, and coding blocks CB (e.g., SBs for VP9 or CTUs/LCUs for HEVC) of the video frame segment F_{VS}_{_}₂ are encoded by the video encoder 902_K (K=2) in the first encoding order R1 that is identical to the encoding order R2 of encoding the video frame segment F_{VS} with only a single column tile as illustrated in FIG. 2.

The operation and configuration of each of the video encoders 902_1-902_K may be same as that of the video encoder 102 shown in FIG. 1. For example, each of the video encoders 902_1-902_K may be configured to employ one of the entropy encoding designs shown in FIGS. 6-8. Since a person skilled in the art can readily understand details of the video encoders 902_1-902_K after reading above paragraphs directed to the video encoder 102, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video encoding apparatus comprising:
a bitstream buffer; and
a first video encoder, arranged to sequentially encode coding blocks of a first video frame segment in a first encoding order, and output encoded data of the coding blocks of the first video frame segment to the bitstream buffer, wherein the first video frame segment is partitioned into a plurality of column tiles each having at least one tile, and the first encoding order is identical to an encoding order of encoding a video frame segment with only a single column tile.

2. The video encoding apparatus of claim 1, wherein the video encoder comprises:
a plurality of entropy encoding circuits, arranged to apply entropy encoding to the column tiles, respectively, wherein a number of the entropy encoding circuits is equal to a number of the column tiles.

3. The video encoding apparatus of claim 1, wherein the video encoder comprises:
a plurality of entropy encoding status buffers, wherein a number of the entropy encoding status buffers is equal to a number of the column tiles; and
an entropy encoding circuit, arranged to:
apply entropy encoding to the column tiles, sequentially and cyclically;
store entropy encoding statuses associated with entropy encoding of the column tiles into the entropy encoding status buffers; and
load the entropy encoding statuses associated with entropy encoding of the column tiles from the entropy encoding status buffers.

4. The video encoding apparatus of claim 1, wherein the video encoder comprises:
a plurality of entropy encoding status buffers, wherein a number of the entropy encoding status buffers is equal to a number of the column tiles; and
a plurality of entropy encoding circuits, each arranged to:
apply entropy encoding to a portion of the column tiles, sequentially and cyclically;
store entropy encoding statuses associated with entropy encoding of the portion of the column tiles into a portion of the entropy encoding status buffers; and
load the entropy encoding statuses associated with entropy encoding of the portion of the column tiles from the portion of the entropy encoding status buffers;
wherein a number of the entropy encoding circuits is smaller than the number of the column tiles.

5. The video encoding apparatus of claim 1, wherein the first video frame segment is a complete video frame.

6. The video encoding apparatus of claim 1, further comprising:
a second video encoder, arranged to sequentially encode coding blocks of a second video frame segment in the first encoding order, and output encoded data of the coding blocks of the second video frame segment to the bitstream buffer, wherein the second video frame segment is partitioned into a plurality of column tiles each having at least one tile, and the first video frame segment and the second video frame segment are different parts of a complete video frame.

7. A video encoding apparatus comprising:
a bitstream buffer; and
a first video encoder, arranged to sequentially encode coding blocks of a first video frame segment, and output encoded data of the coding blocks of the first video frame segment to the bitstream buffer, wherein the first video frame segment is partitioned into a plurality of column tiles each having at least one tile, and adjacent coding blocks located at a same coding block row and located on opposite sides of a column tile boundary are encoded by the first video encoder sequentially.

8. The video encoding apparatus of claim 7, wherein the video encoder comprises:
a plurality of entropy encoding circuits, arranged to apply entropy encoding to the column tiles, respectively, wherein a number of the entropy encoding circuits is equal to a number of the column tiles.

9. The video encoding apparatus of claim 7, wherein the video encoder comprises:
a plurality of entropy encoding status buffers, wherein a number of the entropy encoding status buffers is equal to a number of the column tiles; and
an entropy encoding circuit, arranged to:
apply entropy encoding to the column tiles, sequentially and cyclically;
store entropy encoding statuses associated with entropy encoding of the column tiles into the entropy encoding status buffers; and
load the entropy encoding statuses associated with entropy encoding of the column tiles from the entropy encoding status buffers.

10. The video encoding apparatus of claim 7, wherein the video encoder comprises:
a plurality of entropy encoding status buffers, wherein a number of the entropy encoding status buffers is equal to a number of the column tiles; and
a plurality of entropy encoding circuits, each arranged to:
apply entropy encoding to a portion of the column tiles, sequentially and cyclically;
store entropy encoding statuses associated with entropy encoding of the portion of the column tiles into a portion of the entropy encoding status buffers; and
load the entropy encoding statuses associated with entropy encoding of the portion of the column tiles from the portion of the entropy encoding status buffers;
wherein a number of the entropy encoding circuits is smaller than the number of the column tiles.

11. The video encoding apparatus of claim 7, wherein the first video frame segment is a complete video frame.

12. The video encoding apparatus of claim 7, further comprising:
a second video encoder, arranged to sequentially encode coding blocks of a second video frame segment, and output encoded data of the coding blocks of the second video frame segment to the bitstream buffer, wherein the second video frame segment is partitioned into a plurality of column tiles each having at least one tile, adjacent coding blocks located at a same coding block row and located on opposite sides of a column tile boundary are encoded by the second video encoder sequentially, and the first video frame segment and the second video frame segment are different parts of a complete video frame.

13. A video encoding apparatus comprising:
a bitstream buffer; and
a first video encoder, arranged to sequentially encode coding blocks of a first video frame segment, and output encoded data of the coding blocks of the first video frame segment to the bitstream buffer, wherein the first video frame segment is partitioned into a plurality of column tiles each having at least one tile, the first video encoder starts encoding a second tile of the first video frame segment before encoding of a first tile of the first video frame segment is fully completed, and the first tile and the second tile are horizontally adjacent tiles located on opposite sides of a column tile boundary.

14. The video encoding apparatus of claim 13, wherein the video encoder comprises:
a plurality of entropy encoding circuits, arranged to apply entropy encoding to the column tiles, respectively, wherein a number of the entropy encoding circuits is equal to a number of the column tiles.

15. The video encoding apparatus of claim 13, wherein the video encoder comprises:
a plurality of entropy encoding status buffers, wherein a number of the entropy encoding status buffers is equal to a number of the column tiles; and
an entropy encoding circuit, arranged to:
apply entropy encoding to the column tiles, sequentially and cyclically;
store entropy encoding statuses associated with entropy encoding of the column tiles into the entropy encoding status buffers; and
load the entropy encoding statuses associated with entropy encoding of the column tiles from the entropy encoding status buffers.

16. The video encoding apparatus of claim 13, wherein the video encoder comprises:
a plurality of entropy encoding status buffers, wherein a number of the entropy encoding status buffers is equal to a number of the column tiles; and
a plurality of entropy encoding circuits, each arranged to:
apply entropy encoding to a portion of the column tiles, sequentially and cyclically;
store entropy encoding statuses associated with entropy encoding of the portion of the column tiles into a portion of the entropy encoding status buffers; and
load the entropy encoding statuses associated with entropy encoding of the portion of the column tiles from the portion of the entropy encoding status buffers;
wherein a number of the entropy encoding circuits is smaller than the number of the column tiles.

17. The video encoding apparatus of claim 13, wherein the first video frame segment is a complete video frame.

18. The video encoding apparatus of claim 13, further comprising:
a second video encoder, arranged to sequentially encode coding blocks of a second video frame segment, and output encoded data of the coding blocks of the second video frame segment to the bitstream buffer, wherein the second video frame segment is partitioned into a plurality of column tiles each having at least one tile, the first video frame segment and the second video frame segment are different parts of a complete video frame, the second video encoder starts encoding a third tile of the second video frame segment before encoding of a fourth tile of the second video frame segment is fully completed, and the third tile and the fourth tile are horizontally adjacent tiles located on opposite sides of a column tile boundary.

19. A video encoding method comprising:
sequentially encoding coding blocks of a first video frame segment in a first encoding order; and
outputting encoded data of the coding blocks of the first video frame segment to a bitstream buffer;
wherein the first video frame segment is partitioned into a plurality of column tiles each having at least one tile, and the first encoding order is identical to an encoding order of encoding a video frame segment with only a single column tile.
